(19) United States
(12) Patent Application Publication
(10) Pub. No.: US 2019/0116824 A1
(43) Pub. Date: Apr. 25, 2019

(54) PRODUCTION OF ADDITIVE FREE HAZELNUT BEVERAGE

(71) Applicant: TUBITAK, Ankara (TR)

(72) Inventors: Tarik ÖZTÜRK, Kocaeli (TR); Bengü ÖZTÜRK, Kocaeli (TR); Ferda SEYHAN, Kocaeli (TR); Mehlika BORCAKLI, Kocaeli (TR)

(73) Assignee: TUBITAK, Ankara (TR)

(21) Appl. No.: 16/087,151

(22) PCT Filed: Mar. 21, 2017
(86) PCT No.: PCT/IB2017/051627

§ 371 Date: Sep. 21, 2018

(30) Foreign Application Priority Data
Mar. 21, 2016 (TR) TR 2016/03611

(51) Int. Cl. A23C 11/10; A23L 2/38; A23L 2/46; A23L 2/60; A23L 2/72; A23L 27/10

(52) U.S. Cl. CPC A23C 11/103; A23L 2/38; A23L 2/46; A23L 2/60; A23L 2/72; A23V 2300/38; A23V 2002/00; A23V 2250/606; A23V 2250/61; A23V 2300/24; A23V 2300/31; A23L 27/10

(57) ABSTRACT

A beverage preparation method, including the following steps: grinding natural hazelnut kernels and water together in a bladed grinder at room temperature; removing sediments by filtering through a sieve with a mesh size of 0.5 mm to obtain a filtrate; cooking the filtrate in a pressurized cooking vessel at 110-150° C., for 1 second to 20 minutes; removing sediments formed after cooking by a centrifuge to obtain a sediment-free liquid. The beverage preparation method solves the stability problems by a heat treatment under pressure and centrifugation steps without using food additives and by the heat treatment under pressure with sugar addition to the product gives it a special flavour.

### CROSS REFERENCE TO RELATED APPLICATIONS

This application is the national phase entry of International Application No. PCT/IB2017/051627, filed on Mar. 21, 2017, which is based upon and claims priority to Turkish Patent Application No. TR 2016/03611, filed on Mar. 21, 2016, the entire contents of which are incorporated herein by reference.

### TECHNICAL FIELD

The topic of this invention is the production method of food additive-free stable hazelnut beverage solely made of hazelnut, water and sugar.

### BACKGROUND

Hazelnut is a preferred food by humans for many years because of its health benefits and superior flavour properties. Hazelnuts can be consumed as snacks, hazelnut paste, or hazelnut milk. The demand for hazelnut beverages has increased in recent years. Hazelnut products, such as mixed forms of hazelnut with various plants and hazelnut milk made with various stabilizers, are being developed and patented.

The major disadvantage of hazelnut beverages is the difficulty of preserving their stability against the thermal processing and storage conditions. Thus, it has been mandatory to use food additives in hazelnut beverage formulations. These additives are mostly in the group of thickening agents, emulsifiers, and acidity regulators. Food additives affect consumer preference of the product. Therefore, a product that does not contain additives has significant economic advantages.

Eleven patents have been found related to hazelnut beverage preparation.

Patent ES-A-360032 provides for the production of sterilisable nut milk through the grinding of nuts into a powder form of less than a size of 10 microns, and use of water and pectin as stabilizer.

Patent ES-A-2116916 especially covers the production of beverages from almonds. In this patent, almonds are kept in water with added sweeteners and then homogenized to obtain a paste. It is possible to obtain a beverage by only adding water or stabilizer added water to the paste. Because the centrifugation step is not included in the mentioned process in the Patent ES-A-2116916, sediment is expected in the package. Besides, the beverage in the aforementioned patent is obtained from almonds, which give more stable milk compared to hazelnuts.

Patent ES-A-2095806 is about the production of an almond beverage, which has water activity greater than 0.75. In this patent, almonds and water are ground together and resulting mixture is centrifuged to remove the insoluble particles. Sweetener and emulsifiers are added into the obtained supernatant and then pH is adjusted. In this patent, an emulsifier is used as additive and also, the beverage in this patent is produced from almonds rather than hazelnuts.

In the Patent ES 2040654, some of the nuts are defatted and milk is obtained by grinding the defatted nuts and non-defatted nuts with water in a colloidal mill. The obtained milk is concentrated and preferably dried. Dry powder is produced by this method. In this method, the centrifugation step is not included and powder is produced rather than a stable beverage.

In the patents CN-A-1559304, CN-A-1209303 and CN-A-1063207, nuts are initially soaked in water and centrifugation step is not performed.

In Patent EP 2342980, nuts are ground with water at 75-90° C., and the milled mixture is homogenized in a homogenizer after addition of an emulsifier. The homogenized mixture is centrifuged, the pH of the supernatant is adjusted, and then packaged after UHT sterilization.

In the Patent CN1709162 and U.S. Pat. No. 5,656,321, nuts are defatted and additives such as acidity regulators and thickening agents are added into the beverage.

In Patent GB2413932A, almonds are partially defatted and ground to a paste in dry form, followed by preferably mixing of additives into this paste to obtain an almond beverage. Furthermore, this patent does not have the additional heat treatment and centrifugation steps in order to provide stability, heat treatment is only suggested to provide microbial stability. Acidity regulator and emulsifier are added into the aforementioned product. The applied thermal treatment is not over 100° C. under pressure, but at 75-90° C.

### SUMMARY

Hazelnut beverages are not able to protect their stability when they are exposed to heat treatment and it is not possible to produce additive free stable hazelnut beverage with long shelf-life. Stable hazelnut beverages free of food additives, consisting of only hazelnuts, water and sugar is produced via the processing steps included in this patent. Produced hazelnut milk is exposed to high temperature under pressure for a short time and substances that disrupt the stability are removed to ensure the stability of the hazelnut milk. Besides being additive-free, this hazelnut beverage also has a special flavour due to the treatment above 100° C. with added sugar.

### DETAILED DESCRIPTION OF THE INVENTION

The invention comprises the following steps:
1) grinding of natural (non-heat treated) hazelnut kernels and water together in a bladed grinder at room temperature,
2) removing sediments by filtering through a sieve with a mesh size of 0.5 mm,
3) cooking of filtrate in a pressurized cooking vessel at 110-150° C., preferably at 120° C., for 1 second to 20 minutes and preferably for 5 minutes,
4) removal of sediments by a centrifuge formed after cooking,
5) addition of 8-15% glucose or fructose containing substance to the sediment-free liquid.
6) cooking of sugar containing liquid optionally in the cooking vessel or in the package at 110-150° C. and preferably at 120° C. for 15 minutes until desired aroma has formed,
7) if necessary, sterilization of the vessel-cooked product, followed by aseptic packaging.

At the first step hazelnuts have to be natural. The reason for the preference of natural hazelnuts is that, they form more sediment by heat treatment and the final product is more stable; also, the usage of natural hazelnuts enables the perception of specific aroma and taste.

It is also possible to use roasted hazelnuts to obtain different aroma and taste. It is also possible to use grains, legumes, and other nuts beside hazelnuts to obtain different tastes or modify nutritive value. It is also appropriate to use any different grinder with sufficient crushed power instead of bladed grinder at this step.

The filtration process in the second step is performed smoothly with a sieve containing holes of 0.5 mm diameter. It is also appropriate to change the sieve diameter or use a centrifuge instead of filtration.

Cooking in pressurized chamber in the third step enables the non-use of food additives. High temperature and pressure precipitate substances that may disrupt the stability of the hazelnut beverage and inactivate enzymes in hazelnut.

Thermal treatment (preferably at 120° C. for 15 minutes) would also prevent rancidity resulting from lipase enzyme activity and prevents undesired effects on the product flavour.

Additives are mandatory when this process is not performed over 100° C. and under pressure, as the stability of the product is disrupted and phase separation is observed.

In the fourth step, sediments are removed by centrifugation; however, it is also possible to use filtration instead of centrifugation.

In the fifth step, sucrose is added into the mixture that has been cleared of sediments. Other carbohydrate based sweeteners (glucose syrup, fructose containing glucose syrup, fructose syrup) or different mixtures containing honey or molasses can be used at different ratios at this step to sweeten the mixture.

Alternative sweeteners (high intensity sweeteners or sugar alcohols) cannot be used alone as an alternative, since the flavour compounds that form under pressure in the presence of mono and disaccharides give the characteristic taste to the beverage. Sugar and hazelnuts interact and special flavour of the drink forms after this process. The intensity of this flavour is adjusted by temperature and time.

A further sterilization step is not required if a pressurized thermal treatment at 121° C. for 15 minutes is preferred. However, the product will have a shorter shelf-life if it is produced at lower temperatures and in shorter time. Sterilization step is necessary to store the product for a long time at room temperature. The aroma of the product has to be adjusted by taking this further thermal treatment step into account.

Although it is desired that this product is additive free, the enrichment of this product with bioactive substances such as vitamins and minerals are also within the scope of this patent. It is possible that the sugar is partly replaced by alternative sweeteners to decrease caloric value of this beverage. It is possible to produce additive free hazelnut beverage with different tastes either using alternative sweeteners (high intensity sweeteners or sugar alcohols) or without adding any sweeteners. Although the flavour of such a beverage is different than the flavour of the beverage described in this patent, it is still within the scope of this patent.

Although this beverage is intended for direct consumption, it can be used as an ingredient for other food products such as liquor, pudding, pastry cream or coffee due to its special aroma. Although the production process is described as batch production, continuous production process can also be used. Although the preferred hazelnut kernel to water ratio is 1:12, this ratio can be more or less than 1:12. Although the use of a single hazelnut variety is preferred at the production, the use of more than one hazelnut variety is also within the scope of this patent. it is possible to add different food (other nuts, grains, legumes, etc.) or aroma substances (cocoa, coffee, vanilla, etc.) to this beverage.

### Manner of Industrial Applicability of the Invention

All food processing equipment that are utilized for industrial application of the invention are available on the market, and the processes described in this patent can easily be transferred to the industry.

What is claimed is:

1. A beverage preparation method, comprising the following steps:
a. grinding natural hazelnut kernels and water together in a bladed grinder at room temperature;
b. removing sediments by filtering through a sieve with a mesh size of 0.5 mm to obtain a filtrate;
c. performing a heat treatment to cook the filtrate in a pressurized cooking vessel at 110-150° C., for 1 second to 20 minutes;
d. removing sediments formed after cooking by a centrifuge to obtain a sediment-free liquid.

2. The beverage preparation method according to claim 1, wherein the heat treatment in step c is applied at 120° C. for five minutes.

3. The beverage preparation method according to claim 1, further comprising the step of adding glucose or fructose containing substances to the sediment-free liquid obtained in step d to obtain a sugar-containing liquid.

4. The beverage preparation method according to claim 3, wherein the glucose or fructose containing substances are selected from the group consisting of glucose syrup, fructose containing glucose syrup, fructose syrup, and natural products such as honey or molasses.

5. The beverage preparation method according to claim 3, wherein each of the glucose or fructose containing substances is sucrose.

6. The beverage preparation method according to claim 3, further comprising the step of packaging the sugar-containing liquid.

7. The beverage preparation method according to claim 3, wherein the sugar-containing liquid is cooked in the pressurized cooking vessel or in a package at 110-150° C. until desired aroma has formed.

8. The beverage preparation method according to claim 6, wherein the packaged sugar-containing liquid is cooked in a package at 110-150° C. until desired aroma has formed and a pasteurized or sterilized beverage is obtained.

9. The beverage preparation method according to claim 7, further comprising the step of performing an aseptic filling, after cooking the sugar-containing liquid.

10. The beverage preparation method according to claim 7, wherein a self-specific aroma is obtained by treating hazelnut and fructose or glucose in a liquid matrix under heat and pressure.

11. The beverage preparation method according to claim 1, wherein additional water is added in any step.

12. The beverage preparation method according to claim 1, further comprising the step of adding various bioactive substances comprising vitamins or minerals for enrichment purposes.

13. The beverage preparation method according to claim 1, further comprising the step of adding substances comprising vanilla, cocoa, or coffee to obtain a different taste and aroma.
